(19) United States
(12) Patent Application Publication
(10) Pub. No.: US 2012/0127983 A1
(43) Pub. Date: May 24, 2012

(54) ELECTRONIC DEVICE AND METHOD FOR TRANSMITTING WARNING INFORMATION, AND SECURITY MONITORING SYSTEM

(75) Inventors: PING-YANG CHUANG, Tu-Cheng (TW); YING-CHUAN YU, Tu-Cheng (TW); YING-XIONG HUANG, Tu-Cheng (TW); HSING-CHU WU, Tu-Cheng (TW)

(73) Assignee: HON HAI PRECISION INDUSTRY CO., LTD., Tu-Cheng (TW)

(21) Appl. No.: 12/982,895

(22) Filed: Dec. 31, 2010

(30) Foreign Application Priority Data
Nov. 23, 2010 (TW) 99140271

(51) Int. Cl. H04B 7/216; H04B 7/00; H04N 7/18; G08B 13/14

(52) U.S. Cl. 370/342; 340/568.1; 455/41.2; 348/143; 348/E07.085

(57) ABSTRACT

An electronic device for transmitting warning information to a monitoring device is provided. The monitoring device includes a radio frequency transmitting unit transmitting a wireless signal. The electronic device includes a radio frequency receiving unit, a detector, a wireless transmitting unit, and a processor. The radio frequency receiving unit receives the wireless signal transmitted by the radio frequency transmitting unit when the distance between the radio frequency transmitting unit and the radio frequency receiving unit is less than a preset value. The detector detects the movement or the oscillation of the electronic device. The radio frequency receiving unit generates an anomalous potential to signal the processor to enable the detector when not receiving the wireless signal transmitted through the radio frequency transmitting unit. The processor transmits the warning information to the monitoring device through the wireless transmitting unit when the detector detects that the electronic device moves or oscillates.

### BACKGROUND

1. Technical Field

The present disclosure relates to electronic devices and methods thereof, and security monitoring systems and, particularly, to an electronic device and method for immediately transmitting warning information, and security monitoring system.

2. Description of Related Art

The conventional security monitoring systems usually include video cameras to allow people to observe the monitored items. It is necessary for the security monitoring systems to provide a warning when the monitored items have moved out of a predetermined area.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of a security monitoring system in accordance with an exemplary embodiment.

FIG. 2 is a flowchart of a security monitor method implemented by the security monitoring system of FIG. 1 in accordance with an exemplary embodiment.

### DETAILED DESCRIPTION

Embodiments of the present disclosure are now described in detail, with reference to the accompanying drawings.

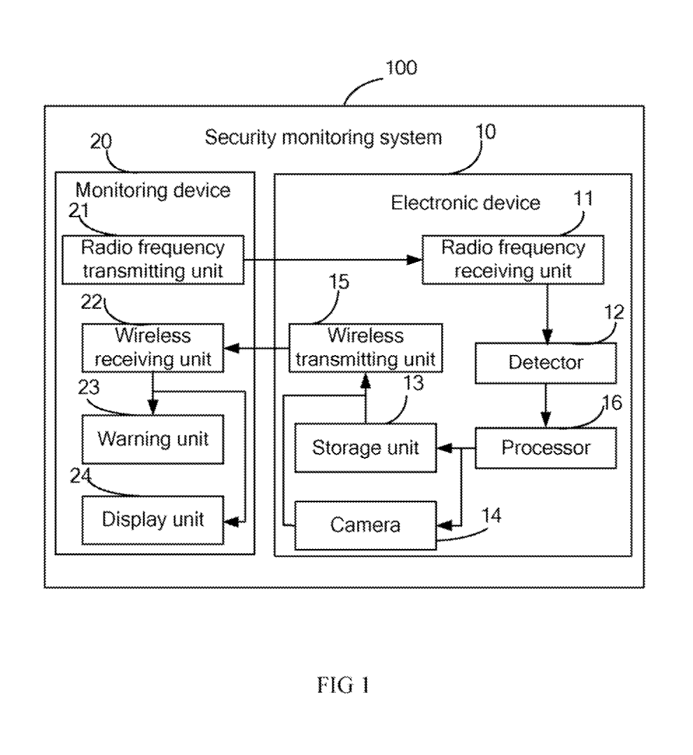

Referring to FIG. 1, a block diagram of a security monitoring system 100 in accordance with an exemplary embodiment is shown. The security monitoring system 100 includes an electronic device 10 and a monitoring device 20. The electronic device 10 may be a computer, or a cell phone. The monitoring device 20 may be a wrist worn device, such as an electronic watch, or other wearable devices.

The electronic device 10 includes a radio frequency receiving unit 11, a detector 12, a storage unit 13, a camera 14, a wireless transmitting unit 15, and a processor 16. The monitoring device 20 includes a radio frequency transmitting unit 21, a wireless receiving unit 22, a warning unit 23, and a display 24.

The radio frequency transmitting unit 21 transmits a wireless signal. In the embodiment, the wireless signal is transmitted in a digital code form. The radio frequency receiving unit 11 receives the wireless signal from the radio frequency transmitting unit 21, and generates a normal potential. In the embodiment, when the distance between the radio frequency transmitting unit 21 and the radio frequency receiving unit 11 is less than a preset value, the signal from the radio frequency transmitting unit 21 can be received by the radio frequency receiving unit 11. Otherwise, the radio frequency receiving unit 11 cannot receive the signal from the radio frequency transmitting unit 21. When not receiving the wireless signal from the radio frequency transmitting unit 21, the radio frequency receiving unit 11 generates an anomalous potential. In the embodiment, the radio frequency transmitting unit 21 and the radio frequency receiving unit 11 may be BLUETOOTH modules or WI-FI modules.

When the radio frequency receiving unit 11 receives the wireless signal from the radio frequency transmitting unit 21, the radio frequency receiving unit 11 generates the normal potential to signal the processor 16 to disable the detector 12. When not receiving the wireless signal transmitted by the radio frequency transmitting unit 21, the radio frequency receiving unit 11 generates the anomalous potential to signal the processor 16 to enable the detector 12.

The detector 12 detects the movement or the oscillation of the electronic device 10. In the embodiment, the detector 12 can be a 2-axis or 3-axis acceleration transducer. The default state of the detector 12 is DISABLED.

The storage unit 13 stores the warning information. The warning information may include acoustic information. In the embodiment, the warning information may further include text messages, such as “Warning!! Warning!! The electronic device is used by an unauthorized user”.

The camera 14 monitors a preset area where the electronic device 10 is placed. When the detector 12 detects that the electronic device 10 moves or oscillates, the processor 16 starts the camera 14 to capture video image of the preset area where the electronic device 10 is placed. In the embodiment, the camera 14 is only started when the detector 12 detects the monitoring electronic device 10 moves or oscillates, to minimize the consumption of the energy.

The wireless transmitting unit 15 can communicate with the wireless receiving unit 22 through conventional communication network, such as GPRS, or CDMA.

The warning unit 23 generates a warning. The warning may be audible and/or a vibration. The display unit 24 displays the text information.

The processor 16 controls the transmission of the signal, including warning information and the video data captured by the camera 14, through the wireless transmitting unit 15, when the detector 12 detects that the monitoring electronic device 10 moves or oscillates.

When the wireless receiving unit 22 receives the signal, the warning unit 23 generates the audible and/or the vibration according to the warning information of the signal, and the display unit 24 displays the video and the text information according to the warning information and the video data of the signal.

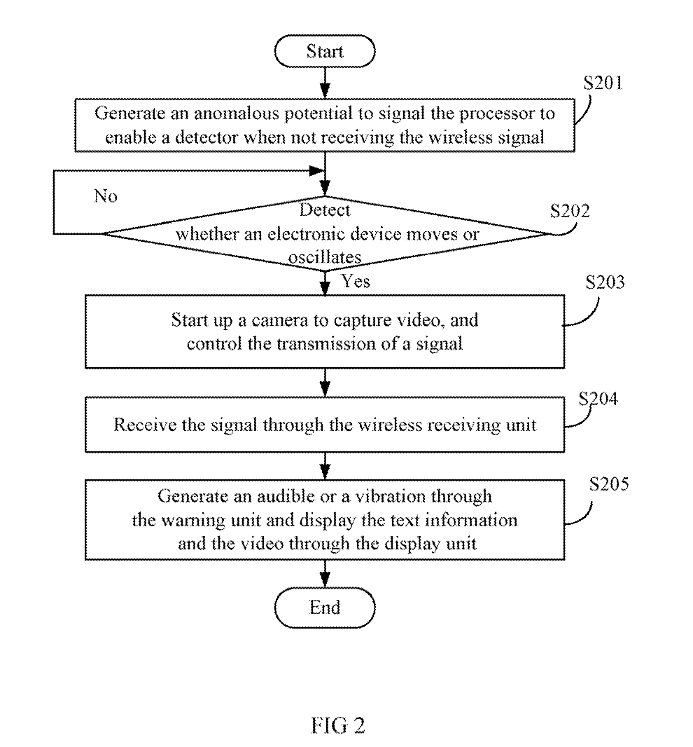

Referring to FIG. 2, a flat chart of a security monitor method in accordance with an exemplary embodiment is shown.

In step S201, the radio frequency receiving unit 11 generates an anomalous potential to signal the processor to enable the detector 12 when not receiving the wireless signal transmitted by the radio frequency transmitting unit.

In step S202, the detector 12 detects whether the electronic device 10 moves or oscillates. If yes, the procedure goes to S203. If no, the procedure repeats.

In step S203, the processor 16 starts the camera 14 to capture video image of the preset area where the electronic device is placed, and controls the transmission of the signal including warning information and video captured by the camera 14 through the wireless transmitting unit 15.

In step S204, the wireless receiving unit 22 receives the signal including warning information and the video data captured by the camera 14.

In step S205, the warning unit 23 immediately generates an audible and/or a vibration according to the warning information of the signal and the display unit 24 immediately displaying the text information and the video according to the warning information and the video data of the signal.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic device for transmitting warning information to a monitoring device, the monitoring device comprising a radio frequency transmitting unit for transmitting a wireless signal, the electronic device comprising:
a radio frequency receiving unit able to receive the wireless signal from the radio frequency transmitting unit when the distance between the radio frequency transmitting unit and the radio frequency receiving unit is less than a preset value;
a detector configured to detect the movement or oscillation of the electronic device;
a wireless transmitting unit configured to wirelessly transmit warning information; and
a processor configured to control the wireless transmitting unit to transmit the warning information to the monitoring device when the detector detects that the electronic device moves or oscillates;
wherein the radio frequency receiving unit generates an anomalous potential to signal the processor to enable the detector when not receiving the wireless signal from the radio frequency transmitting unit;

2. The electronic device as described in claim 1, wherein the radio frequency receiving unit generates a normal signal to signal the processor to disable the detector when receiving the wireless signal transmitted from the radio frequency transmitting unit.

3. The electronic device as described in claim 1 further comprising a storage unit, wherein the warning information is stored in the storage unit.

4. The electronic device as described in claim 1 further comprising a video camera, wherein the processor starts the camera to capture video image of a preset area of the electronic device when the detector detects that the electronic device moves or oscillates, the processor further transmits the video data to the monitoring device through the wireless transmitting unit.

5. The electronic device as described in claim 1, wherein the radio frequency transmitting unit and the radio frequency receiving unit are BLUETOOTH modules.

6. The electronic device as described in claim 1, wherein the radio frequency transmitting unit and the radio frequency receiving unit are WI-FI modules.

7. A method for transmitting warning information from an electronic device to a monitoring device, the electronic device comprising a radio frequency receiving unit, a wireless transmitting unit, and a detector, the monitoring device comprising a radio frequency transmitting unit, the method comprising:
generating an anomalous potential through the radio frequency receiving unit when the radio frequency receiving unit can not receive the wireless signal transmitted by the radio frequency transmitting unit;
enabling the detector according to the anomalous potential;
detecting whether the electronic device moves or oscillates through the detector; and
transmitting the warning information to the monitoring device when the detector detects the electronic device moves or oscillates.

8. The method as described in claim 7, wherein the method further comprises:
generating a normal potential through the radio frequency receiving unit when the radio frequency receiving unit receives the wireless signal transmitted by the radio frequency transmitting unit; and
disabling the detector according the normal potential.

9. The method as described in claim 7, the electronic device further comprising a camera, wherein the method further comprises:
starting the camera to capture video of the a preset value of the electronic device through the camera when the detector detects that the electronic device moves or oscillates; and
transmitting the video data to the monitoring device through the wireless transmitting unit.

10. A security monitoring system comprising:
an electronic device comprising:
a radio frequency receiving unit to receive wireless signal;
a detector to detect whether the electronic device moves or oscillates;
a wireless transmitting unit to wirelessly transmit warning information; and
a processor to control the transmitting unit to transmit warning information when the detector detects that the electronic device moves or oscillates; and
a monitoring device comprising:
a radio frequency transmitting unit to transmit wireless signal;
a wireless receiving unit to wirelessly receive the warning information transmitted by the wireless transmitting unit; and
a warning unit to generate a warning when the wireless receiving unit receives the warning information;
wherein the radio frequency receiving unit receives the wireless signal transmitted by the radio frequency transmitting unit when the distance between the radio frequency transmitting unit and the radio frequency receiving unit is less than a preset value, the radio frequency receiving unit generates an anomalous potential to signal the processor to enable the detector when not receiving the wireless signal transmitted by the radio frequency transmitting unit.

11. The security monitoring system as described in claim 10, wherein the radio frequency receiving unit generates a normal potential to signal the processor to disable the detector when the radio frequency receiving unit receives the wireless signal transmitted by the radio frequency transmitting unit.

12. The security monitoring system as described in claim 10 further comprising a storage unit, wherein the warning information is stored in the storage unit.

13. The security monitoring system as described in claim 10, wherein the electronic device further comprises a camera to capture video image of the a preset area of the electronic device when the detector detects that the electronic device moves or oscillates, the processor transmits the video data to the monitoring device, the monitoring device further comprises a display unit to display the video.

14. The security monitoring system as described in claim 10, wherein the wireless transmitting unit is communication with the wireless receiving unit through the GPRS.

15. The security monitoring system as described in claim 10, wherein the wireless transmitting unit is communication with the wireless receiving unit through the CDMA.

16. The security monitoring system as described in claim 10, wherein the radio frequency transmitting unit and the radio frequency receiving unit are BLUETOOTH modules.

17. The security monitoring system as described in claim 10, wherein the radio frequency transmitting unit and the radio frequency receiving unit are WI-FI modules.
